(19) United States
(12) Patent Application Publication
(10) Pub. No.: US 2012/0112880 A1
(43) Pub. Date: May 10, 2012

(54) System For Establishing Geo-Fence For Dispersing Volunteer Skill Sets

(75) Inventor: Richard C. Meyers, Longboat Key, FL (US)

(73) Assignee: System Planning Corporation, Arlington, VA (US)

(21) Appl. No.: 13/289,991

(22) Filed: Nov. 4, 2011

Related U.S. Application Data
(60) Provisional application No. 61/411,422, filed on Nov. 8, 2010.

(51) Int. Cl. G08B 29/00

(52) U.S. Cl. 340/5.54; 340/5.65

(57) ABSTRACT

The present invention provides a system for establishing a geo-fence for assigning and dispersing human resource assets in a disaster relief situation. The system of the present invention provides a method for deploying a ready-response volunteer force in which volunteers are assigned based on their skill sets and the needs or the situation. Volunteers may be notified, updated, and contacted via location based devices. The geo-fence of the present invention may incorporate mobilization centers, communication centers and the logistic assets.

### PRIORITY CLAIMS

The present invention claims priority to U.S. Provisional Patent Application No. 61/411,422, filed Nov. 8, 2010. No new matter has been added.

### BACKGROUND OF THE PRESENT INVENTION

1. Field of the Present invention

The present invention relates to a method of establishing a Geo-fence to organize and disperse volunteers based on their skill sets. More specifically, the present invention relates to establishing a Geo-fence in a relief situation or military operation to establish a mobilization center from which volunteers with priority skill sets may be routed to clinics, stations, and distribution points.

2. Description of Related Art

Three problems related to UN Volunteers and the United Nations System are evident and recurrent from country to country and conflict to conflict. The first tension is between humanitarian activities and the political-military side of the United Nations. The second is between the grassroots orientation of assistance and the headquarters orientation of the UN bureaucracy. The third is between the UN system that frequently takes the lead in complex emergencies and those outside of it with skills and energy to contribute.

The typical UN Volunteer identities motivation, commitment and dedication as “the basic elements of volunteerism.” In a larger sense, however, these are also the desirable characteristics of international civil servants with whom UN Volunteers work on a daily basis. Nor is the distinguishing factor that one group is “professional” or “more professional than the other. Perhaps the difference lies not in motivation or skills but rather in relationship to the UN system itself. The broader issue for the international community concerns how to structure institutions in ways that take fuller advantage of the resources coming from outside the UN system proper. An underlying policy issue concerns the need for a fundamental rethinking of the meaning of the term “volunteer”.

More than 1,800 UN Volunteers are currently supporting UN peacekeeping operations in 11 countries worldwide: Afghanistan (UNAMA), Burundi (UNOB), Democratic Republic of the Congo (MONUC), Eritrea and Ethiopia (UNMEE), Haiti (MINUSTAH), Ivory Coast (UNOCI), Kosovo (UNMIK), Liberia (UNMIL), Sierra Leone (UNAMSIL), Sudan (UNMIS), and Timor-Leste (UNMISET). They constitute nearly thirty percent of all international civilian staff, where they work in over one hundred functional categories, from human rights officers to supply managers, and electoral observers to press officers.

The frustration of volunteers with the lack of adequate support for their efforts from the UN systems is apparent throughout, although balanced by their appreciation for the difficulties the system is facing. The need for ensuring fuller and more creative use of volunteer resources is self-evident. UN Volunteers represent an enormous reservoir of skills, experience, and energy. Not only do they extend the effectiveness of the UN system; they also help offset some of its acknowledged shortcomings.

The present state of the art has resulted in mounting frustrations as UN Volunteers admittedly are inadequately supported by the present bureaucratic system leaving some calling for a permanent UN ready-response force.

### SUMMARY OF THE PRESENT INVENTION

The present invention seeks to promote a virtual ready-response force and a means to appropriately and effective position valuable volunteer resources. A geo-fence may be dynamically generated as in a radius around a store or point location. A geo-fence may also be a predefined set of boundaries, like school attendance zones or neighborhood boundaries. Each geo-fence may included a forward mobilization operating center strategically positioned within the theatre of operation to serve the greatest number of UN volunteers acting as a point of entry for nationals within the conflict/disaster area partnering with UN personnel as volunteers. Hence, the UN volunteer who is actively recruiting nationals to serve may be fully supported in terms of orienting and equipping new volunteers through a new volunteer training program.

A user in a geo-fence area may preferably receive generated notification. The user may be registered within the geo-fenced area or preregister via website and receive authorization before arrival at conflict/disaster site. The user's mobile phone device or other location aware device will receive generated notification from the geo-fence database and control center. The user will also be able to communicate with the geo-fence operation center by text via their mobile phone or other location aware device.

To address the problems and limitations noted above, a method for establishing a geo-fence for coordinating and supporting volunteer efforts is provided. The object of the present invention is to overcome the shortcomings disclosed in the prior art. The accompanying drawing, which is incorporated in and constitute part of the specification, illustrates an embodiment of the present invention and together with the description, serves to explain the principles of the present invention.

### BRIEF DESCRIPTION OF THE DRAWINGS

FIG. 1 is a method flow chart describing three stages associated with an embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated method are contemplated as would normally occur to one skilled in the art.

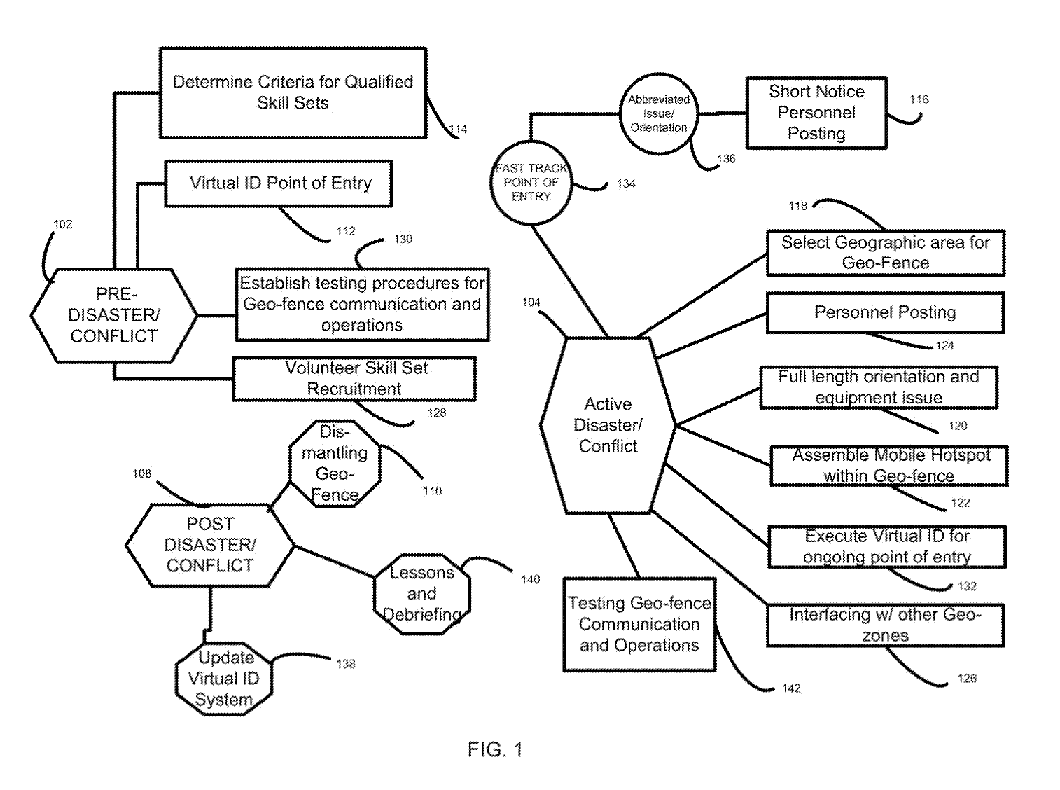

With reference now to FIG. 1, and for the purposes of explanation, the basic method of the present invention may consist of at least 3 operational stages which will now be discussed. The overall operational stages comprise Pre-Conflict/disaster operations 102, Active-Conflict/disaster operations 104, and Post-Conflict/disaster operations 108.

As shown in FIG. 1, the first operational stage, Pre-Conflict/disaster Operations 102 comprises establishing a virtual identification and authentication system 112 and establishing rules and procedures agreed upon between professional authorities and relief organizations for the criteria for qualified skill sets 114. Preferably, testing procedures, protocols, and operational procedures for a geo-fence 130 may be established in the Pre-Conflict/Disaster phase 102.

The virtual identification system 112 will enable registered users to receive notification about available positions and volunteer opportunities, travel instructions, as well as situational updates via text or some other location based device. Preferably, an emergency responder's website will be established during the Pre-disaster operational 102 stage and accessible for immediate registration for the duration of a conflict or disaster. Providing an easily accessible website and registration process preferably may enhance an active volunteer recruitment program during a Pre-Conflict/disaster stage 102. Also preferably, according to one embodiment of the present invention, the virtual identification and authorization system 112 may store the Mobile phone Identification Number (MIN) of the user allowing instant authentication of the user.

As further shown in FIG. 1, the second operational stage in the present invention, takes place as an immediate response to assessing the extent of damage on the ground and assigning the geographic coordinates of geo-fence 118. Preferably, national authorities will work in conjunction with multinational officials to establish the geo-fence zones. However, in the absence of any civil authority or national military authority, the immediate responders may establish geo-fence operations and report the geographic area coordinates of each geo-fence zone to acting authorities. Next, the priority will shift to assembling a mobile hot-spot within the geo-fence 122 and executing the previously established virtual identification system 132. According to a preferred embodiment of the present invention, testing the geo-fence communication and operational systems 142 preferably takes place no later than forty-eight hours after reporting geographic area coordinates following pre-established guidelines.

Preferably, more than one geo-fence zone may be established. Once fully operational after establishing a geo-fence zone, each geo-fence zone may begin interfacing databases and communication systems 126 with other established geo-fence zones. By saturating the area of operations for disaster relief, this step in the Active Disaster operational stage 104 may ensure that the appropriate needs of providers and victims throughout the entire relief area of operations. Preferably, by matching specific operational needs with the most appropriate and qualified volunteers based on skill sets, the individual tasks of each strategically assigned volunteer may contribute to more efficient relief efforts.

According to a preferred embodiment of the present invention, civilian volunteers may be selected from among the indigenous population, at which time the geo-fence mobilization center may serve as a point of entry into the virtual ID system 132. Preferably, before assigning volunteers to duty, a full-length orientation may be offered to properly train and equip each volunteer 120 and then assign and position civilian volunteers based on where their particular skill set may be determined to be most useful 124. Preferably, providing training for civilian nations and multinational volunteers may provide a full-service support of active volunteers relieving active volunteers of the time consuming responsibility of training and orienting new volunteers.

As further shown in FIG. 1, the fast track point of entry 134 is enacted when immediately needed positions require immediate manning. The geo-fence mobilization center is best positioned to receive a fast track volunteer at their point of entry, deliver an abbreviated orientation 136, equip the newly arrived volunteer, and post personnel on short notice 116. All the while ensuring that volunteers are in full communication via mobile device or location based device. In the instance that nationals do not have a mobile device, they may receive as mobile device or location based device at their point of entry as a part of their equipment issue.

The operations of the geo-fence zones can be managed indefinitely. However, when conflict/disaster relief operation are concluded, termination of the geo-fence zones may require the dismantling of the geo-fence area 110. Preferably the procedures for this stage are also established 130 in the Pre-disaster operations 102. Also preferably, formal debriefing procedures for volunteers may be conducted 140 within the geo-fence mobilization center during dismantling procedures. Finally, the virtual ID system should be updated 138 during the Post-Conflict//Disaster 108.

Communication System

In accordance with a preferred embodiment of the present invention, reporting may be made via a wireless connection to a satellite mode to communicate with a satellite system such as Globalstar or Orbcomm. Preferably, such a satellite device will be a device such as the Axxon, AutoTracker, or the like, or a customized Orbcomm VHF satellite GPS tracking communications device which may be adapted with Zigbee interface antenna devices to incorporate them into the overall LAN architecture of the security system: these devices include a satellite transceiver, GPS receiver, a customized Zigbee wireless antenna with a serial (Ax Tracker) or duplex (OrbComm) interface.

In accordance with a preferred embodiment of the present invention, the reporting may also be made using a wireless system independent from the satellite system. According to this embodiment, wireless signals may be transmitted to a wireless relay, base station or the like for routing and transmission to a chosen centralized location independent from or in combination with the transmissions made from the satellite system. In accordance with this alternative embodiment, signals may also be received by the communications manager and wireless interface from such external wireless networks as well.

According to a preferred embodiment of the present invention, it is preferred that the wireless communications used within the present invention will be based on the Zigbee (IEEE 802.15.4) standard. This standard transmits RF signals in the 2.4 GHz ISM band and operates with low power consumption due to its relatively slower data transmission rate (128 Kpps-250 Kbps). This approach enables additional capacity and flexibility of design through an up to 255 node pico-network. Communications are simplex or duplex in design, meaning that data can be assessed in either a push or pull process.

As referred to above, all communications of the present invention may be designed to be duplex or simplex in nature. Further, as needs require, the processes for transmitting data to and from the present invention may be designed to be push or pull in nature. Still, further, each feature of the present invention may be made to be remotely activated and accessed from distant monitoring stations. For example, as detailed above, each system and subsystem of the present invention may be designed to send, receive, report and request information via the wireless and/or satellite systems so as to continually maintain and update geo-fence communication.

Remote Monitoring

To support and monitor the dataflow generated by the present invention, it is preferred that users establish a centralized location to collect and analyze data. This central location or “data fusion center” would preferably consolidate all tracking signals, sensor alarms and reports generated by the monitoring systems and provide further context and links with current intelligence.

Preferably, such a data fusion center will receive such source information in a variety of formats such as Electronic Data Interchange, XML, E-mail, HTML and flat text files. After receiving such data, the data fusion center preferably would act to process information to identify anomalies. With this data collected and processed, analyst may calculate statistics and probability of detection models used for decision support. In short, such a data fusion center would preferably provide a consolidated source of information that could be used to assist agencies.

In response to limitations and problems recurrent in the relationship between UN Volunteers and the United Nations System, the present invention provides a system of establishing a geo-fence for volunteers working within a large bureaucracy. The present invention provides a virtual ready-response force while retaining the flexibility to augment the force as the situation warrants. In addition, the present invention provides a structure of support and communication that is non-existent in the prior art.

What is claimed is:

1. A method of establishing an impromptu geo-fence to organize manpower and to control access to selected materials, the method comprising:
assigning coordinates demarking a geo-fenced area within a larger geographic area;
establishing a supply database including data regarding location and type of selected equipment and materials within the geofenced area;
associating an access level to selected equipment and materials;
inputting access levels into the supply database;
identifying available workers within the geo-fenced area;
establishing a profile for available workers which includes a skill set for the workers; and
assigning an access code to a worker based on the established profile.

2. The method of claim 1, wherein the method further comprises granting access to supplies based on the assigned access code.

3. The method of claim 2, wherein the method further comprises determining skill set needs within the geofenced area.

4. The method of claim 3, wherein the method further comprises identifying available workers within the geofenced area based on established profiles.

5. The method of claim 4, wherein the method further comprises generating requests for needed workers with selected skill sets.

6. The method of claim 5, wherein the method further comprises providing an RFID tagged identification card to selected workers within the geofenced area to identify and locate the workers.

7. The method of claim 6, wherein the method further comprises providing one or more mobile hotspots within the geofenced area.

8. The method of claim 7, wherein the method further comprises:
updating supply needs; and
updating geofence coordinates based on updated supply needs.

9. The method of claim 8, wherein the method further comprises:
assigning workers a designation number associated with a Mobile Identification Number; and
tracking and identifying the worker using the Mobile Identification Number.

10. The method of claim 9, wherein the method further comprises:
identifying adjacent geofenced areas; and
requesting worker data from adjacent geofenced areas.

11. An apparatus for establishing an impromptu geo-fence to organize manpower and to control access to selected materials, the apparatus comprising:
a receiving element for receiving RFID data and data regarding manpower needs within an identified region; and
a processor configured to analyze RFID data and data regarding manpower needs, wherein the processor is further configured to establish a geofenced area based on received data and to generate requests for manpower and to control access to selected material.

12. The apparatus of claim 11, wherein the processing element is further configured to:
assign coordinates demarking a geo-fenced area within a larger geographic area;
establish a supply database for location and type of selected equipment and materials within the geofenced area;
associate an access level to selected equipment and materials;
input access levels into the supply database;
identify available workers within the geo-fenced area;
establish a profile for available workers which includes the skill set of the workers; and
assign an access code to workers based on the established profile.

13. The apparatus of claim 12, wherein the processing element is further configured to grant access to supplies based on the assigned access code.

14. The apparatus of claim 13, wherein the processing element is further configured to determine skill set needs within the geofenced area.

15. The apparatus of claim 14, wherein the processing element is further configured to identify available workers within the geofenced area based on their established profile.

16. The apparatus of claim 15, wherein the processing element is further configured to generate requests for needed workers with selected skill sets.

17. The apparatus of claim 16, wherein the processing element is further configured to:
update supply needs; and
update geofence coordinates based on updated supply needs.

18. The apparatus of claim 18, wherein the processing element is further configured to:
assign a worker a designation number associated with a Mobile Identification Number; and
track and identify the worker using the Mobile Identification Number.
